(19) United States
(12) Patent Application Publication
(10) Pub. No.: US 2025/0387739 A1
(43) Pub. Date: Dec. 25, 2025

(54) MODULE FOR SEPARATING AN ANALYTE FROM A CONTAINMENT

(71) Applicant: IMEC VZW, Leuven (BE)

(72) Inventors: Kherim Willems, Sint-Joris-Weert (BE); Naghmeh Fatemi, Oud-Heverlee (BE)

(21) Appl. No.: 19/248,084

(22) Filed: Jun. 24, 2025

(30) Foreign Application Priority Data
Jun. 25, 2024 (EP) 24184363.0

(51) Int. Cl. B01D 43/00

(52) U.S. Cl. CPC B01D 43/00

(57) ABSTRACT

A module for separating an analyte from a contaminant is provided. The module includes a fluidic channel for a liquid flowing therethrough. The liquid includes the analyte and the contaminant. The module also includes a plurality of capture sites in the fluidic channel, and a plurality of electrodes arranged near the capture sites. By operating the electrodes, both an attractive force and a repulsive force, acting on a target particle can be realized. The attractive force and/or repulsive force are tuneable so that the forces acting on the target particle create a local potential minimum at one of the capture sites, thereby capturing the target particle at the capture site. The target particle is either the analyte or the contaminant.

### CROSS-REFERENCE TO RELATED APPLICATIONS

The present application is a non-provisional patent application claiming priority to European Patent Application No. 24184363.0, filed Jun. 25, 2024, the contents of which are hereby incorporated by reference.

### FIELD OF THE DISCLOSURE

The present disclosure relates to manipulating target particles in a liquid and in particular to modules for separating an analyte from a contaminant--the analyte or the contaminant being the target particles-by capturing the target particles from the liquid.

### BACKGROUND

In the life sciences industry, the ability to sample, sort, separate, characterize, and quantify the contents of a mixture-such as a particular (set of) molecule(s) (e.g., proteins or biomarkers) from a complex mixture (e.g., urine, blood or a bioreactor sample)-is useful for a variety of applications. These applications can, for instance, range from the quantification of biomarkers in blood, over determining the number of aggregates in a protein solution, to validating the purity of a viral vector production in gene therapy. Furthermore, for vaccine and drug delivery applications using nanoparticles (e.g., viral vectors or lipid vesicles), validating the size distribution and particle content of the synthesized cargo is useful for determining good manufacturing practices (GMP) and obtaining regulatory approval.

However, a challenge in current biomolecule manufacturing (e.g., in particular for recombinant viral vectors and lipid-based nanoparticles) is that impurities often have (e.g., highly) similar composition and physicochemical properties compared to the desired (e.g., therapeutic) biomolecules. Traditional purification techniques-which may rely on separating based on a single property like charge, size, or hydrophobicity-are therefore may be inadequate for (e.g., effectively) removing such impurities. High-yield processes struggle with selectively removing rare undesirable biomolecules, and low-yield processes have difficulty selectively concentrating the rare desirable therapeutic agents.

Further, production, purification, and analysis are often performed using multiple disconnected tools and systems. This may cause extensive product handling and sampling to be used, increasing contamination, and error risks while also driving up manufacturing costs and time.

It would be useful to have a module to address at least some of the concerns outlined hereinabove.

### SUMMARY

The present disclosure provides good modules for separating an analyte from a contaminant, either of them being target particles to be captured by the module. Further, the present disclosure provides (e.g., good) systems and methods associated therewith. This is accomplished by modules, systems, and methods according to the present disclosure.

The present disclosure provides a capture site that can be tuned (e.g., through its manufacture and/or its operation) to a particular species of target particles. Embodiments of the present disclosure provide a target particle that can be captured selectively with respect to a further compound (e.g., an analyte or a contaminant).

Embodiments of the present disclosure provide that virtually any species of target particles can be targeted for capture.

Embodiments of the present disclosure provide that a system may be manufactured in a more or less universal way (e.g., not purpose-build for a specific application), but can be configured towards a particular application through the modules it comprises and/or the manner in which it is operated. Embodiments of the present disclosure provide that a system used for one application can be relatively easily reconfigured towards another application.

Embodiments of the present disclosure provide that the forces (e.g., electric and/or hydrodynamic forces) acting on the target particle can be modulated.

Embodiments of the present disclosure provide that complex (e.g., multipole) electric fields can be generated, thereby inducing effects such as electrorotation. Embodiments of the present disclosure that still further forces and/or effects-such as electrophoretic and electro-osmotic forces-may be leveraged.

Embodiments of the present disclosure that capture devices can be highly parallelized/multiplexed within a single module and/or system. Embodiments of the present disclosure that the module and/or system can include (e.g., comprise) a plurality of capture sites tuned towards different target particles, allowing for the efficient capturing of various types of target particles in a single module/system.

Embodiments of the present disclosure that target particles can be captured from complex mixtures, such as a urine, blood or a bioreactor samples.

Embodiments of the present disclosure that captured target particles can be detected, analysed and/or separated from the liquid.

Embodiments of the present disclosure provide that the electrodes can be protected from chemical (e.g., corrosion) and physical (e.g., delamination) damage.

Embodiments of the present disclosure provide that the module can be fabricated in a relatively easy and economical manner. Embodiments of the present disclosure provide that they can be implemented with conventional technologies.

Embodiments of the present disclosure provide that the modules can be used in various application areas, for many of which a reliable, non-destructive method to characterize certain analytes of interest may currently be lacking, such as an integrated all-in-one system.

The separation modules in accordance with the present disclosure are (e.g., especially) suitable for (e.g., adapted to) being integrated in a system together with other modules (e.g., one or more production, further separation or analysis modules). Such a modular system provides a complete and integrated all-in-one module, starting from reagents and taking them-for instance-through synthesis, purification, and analysis to eventually output the desired analyte (e.g., biomolecule).

In a first aspect, the present disclosure relates to a module for separating an analyte from a contaminant, comprising: i) a fluidic channel for flowing therethrough a liquid comprising the analyte and the contaminant; ii) a plurality of capture sites in the fluidic channel; and iii) a plurality of electrodes arranged near the capture sites, such that by operating the electrodes both an attractive force and a repulsive force acting on a target particle can be realized, the attractive force and/or repulsive force being tuneable so that the forces acting on the target particle create a local potential minimum at one of the capture sites, thereby capturing the target particle at the capture site, the target particle being either the analyte or the contaminant.

In a second aspect, the present disclosure relates to a system comprising a plurality of fluidically and/or electronically coupled modules, at least one of the modules being a module according to any embodiment of the first aspect.

In a third aspect, the present disclosure relates to a method for separating an analyte from a contaminant, the method comprising: a) flowing a liquid comprising the analyte and the contaminant through the fluidic channel of a module as provided (e.g., defined) in any embodiments of the first aspect; and b) operating the plurality of electrodes so as to realize both the attractive force and the repulsive force acting on the target particle, and tune the attractive force and/or repulsive force so that the forces acting on the target particle create a local potential minimum at one of the capture sites, thereby capturing the target particle at the capture site, wherein the target particle is either the analyte or the contaminant.

Aspects of the disclosure are set out in the accompanying claims. Features from the dependent claims may be combined with features of the independent claims and with features of other dependent claims as appropriate and other features not explicitly set out in the claims.

The present disclosure provides a more efficient, stable and reliable device over conventional devices.

The above and other characteristics and features of the present disclosure will become apparent from the following detailed description, taken in conjunction with the accompanying drawings, which illustrate, by way of example, the principles of the disclosure. This description is includes examples and do not limit the scope of the disclosure. The reference figures below refer to the attached drawings.

### BRIEF DESCRIPTION OF THE FIGURES

The above, as well as additional, features will be better understood through the following illustrative and non-limiting detailed description of example embodiments, with reference to the appended drawings.

FIG. 1 is a graph of a potential energy of a particle as a function of its distance in accordance with example embodiments of the present disclosure, also schematically showing the particle being pulled into a local potential minimum.

FIG. 2 schematically depicts a modular system in accordance with an example embodiment of the present disclosure.

FIG. 3 is a schematic view of a module in accordance with an example embodiment of the present disclosure.

FIG. 4 is a cross-sectional view (e.g., perpendicular to the flow direction) of a fluidic channel in accordance with an example embodiment of the present disclosure.

FIG. 5, FIG. 6, and FIG. 7 are schematic views of different stages in a first way to use a module in accordance with an example embodiment of the present disclosure.

FIG. 8, FIG. 9, and FIG. 10 are schematic views of different stages in a second way to use a module in accordance with an example embodiment of the present disclosure.

FIG. 11 schematically depicts a capture device in a module in accordance with an example embodiment of the present disclosure.

FIG. 12 schematically depicts a further capture device comprising a through-hole in accordance with another example embodiment of the present disclosure.

In the different figures, the same reference signs refer to the same or analogous elements.

All the figures are schematic, not necessarily to scale, and generally show parts which are necessary to elucidate example embodiments, wherein other parts may be omitted or merely suggested.

### DETAILED DESCRIPTION

The present disclosure will be described with respect to particular embodiments and with reference to certain drawings but the disclosure is not limited thereto but only by the claims. The drawings described are schematic and are non-limiting. In the drawings, the size of some of the elements may be exaggerated and not drawn to scale for illustrative purposes. The dimensions and the relative dimensions may not correspond to actual reductions to practice of the disclosure.

Furthermore, the terms first, second, third, and the like in the description and in the claims, are used for distinguishing between similar elements and not necessarily for describing a sequence, either temporally, spatially, in ranking or in any other manner. The terms so used are interchangeable under appropriate circumstances and that the example embodiments of the disclosure described herein are capable of operation in other sequences than described or illustrated herein.

Moreover, the terms top, bottom, over, under, and the like in the description and the claims are used for descriptive purposes and not necessarily for describing relative positions. The terms so used are interchangeable with their antonyms under appropriate circumstances and that the embodiments of the disclosure described herein are capable of operation in other orientations than described or illustrated herein.

The term “comprising”, used in the claims, should not be interpreted as being restricted to the means listed thereafter; it does not exclude other elements or steps. It is thus to be interpreted as specifying the presence of the stated features, integers, steps, or components as referred to, but does not preclude the presence or addition of one or more other features, integers, steps or components, or groups thereof. The term “comprising” therefore covers the situation where only the stated features are present and the situation where these features and one or more other features are present. Thus, the scope of the expression “a device comprising means A and B” should not be interpreted as being limited to devices consisting only of components A and B. It means that with respect to the present disclosure, the only relevant components of the device are A and B.

Similarly, the term “coupled”, also used in the claims, should not be interpreted as being restricted to direct connections only. The terms “coupled” and “connected”, along with their derivatives, may be used. These terms are not intended as synonyms for each other. Thus, the scope of the expression “a device A coupled to a device B” should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Reference throughout this specification to “one embodiment” or “an embodiment” means that a particular feature, structure, or characteristic described in connection with the embodiment is included in at least one embodiment of the present disclosure. Thus, appearances of the phrases “in one embodiment” or “in an embodiment” in various places throughout this specification are not necessarily all referring to the same embodiment, but may. Furthermore, the particular features, structures, or characteristics may be combined in any suitable manner, as would be apparent from this disclosure, in one or more embodiments.

Similarly, in the description of example embodiments of the present disclosure, various features of the disclosure are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed disclosure requires more features than are expressly recited in each claim. Rather, as the following claims reflect, inventive aspects lie in less than all features of a single foregoing disclosed embodiment. Thus, the claims following the detailed description are hereby (e.g., expressly) incorporated into this detailed description, with each claim standing on its own as a separate embodiment of this disclosure.

Furthermore, while some embodiments described herein include some but not other features included in other embodiments, combinations of features of different embodiments are meant to be within the scope of the disclosure, and form different embodiments, as would be understood by those in the art. For example, in the following claims, any of the claimed embodiments can be used in any combination.

In the description provided herein, numerous specific details are set forth. However, embodiments of the disclosure may be practised without these specific details. In other instances, well-known methods, structures, and techniques have not been shown in detail in order not to obscure an understanding of this description.

The following terms are provided to aid in the understanding of the disclosure.

As used herein, and unless otherwise specified, the term “analyte” refers to a substance (e.g., a particle) that is of interest. Typically, the analyte may be separated, detected, measured, analysed, etc. Examples of analytes include, but are not limited to, biomolecules, macromolecules, small molecules, and ionic species. In some embodiments, the analyte may be an intermediate product, being an intermediary towards a final product that is to be formed in the (e.g., modular) system.

As used herein, and unless otherwise specified, the term “biomolecules” refers to molecules that are derived from or are involved in biological processes. Examples of biomolecules include, but are not limited to, proteins, enzymes, antibodies, nucleic acids (such as DNA or RNA), lipids and carbohydrates.

As used herein, and unless otherwise specified, the term “macromolecule”-as defined by IUPAC-refers to a molecule of high relative molecular mass, the structure of which essentially comprises the multiple repetition of units derived, actually or conceptually, from molecules of low relative molecular mass. Such a molecule may, for example, comprise in excess of (e.g., about) 1000 atoms. Many of the biomolecules mentioned above are also macromolecules. Other examples include non-biological polymers.

As used herein, and unless otherwise specified, the term “small molecule” refers to a molecule having a molecular weight less than or equal to 1000 Da. Examples of small molecules include small biomolecules and non-biological molecules (e.g., chemical compounds).

As used herein, and unless otherwise specified, the term “contaminant” refers to a species that is undesired. Typically, the contaminant may interfere with or confound the (e.g., desired) separation, detection, measurement, analysis, etc. of the analyte. Examples of contaminants include, but are not limited to, impurities, debris, side-products and other substances that are different from-even while they may be chemically and/or physically very similar to-the analyte. Like the analyte, the contaminant may thus, in some instances, be a biomolecule, macromolecule, small molecule, or ionic species.

As used herein, and unless otherwise specified, the term “target particle” refers to the particle that is desired to be captured at a capture site. The target particle can be either an analyte or a contaminant, depending on the specific application and separation goals.

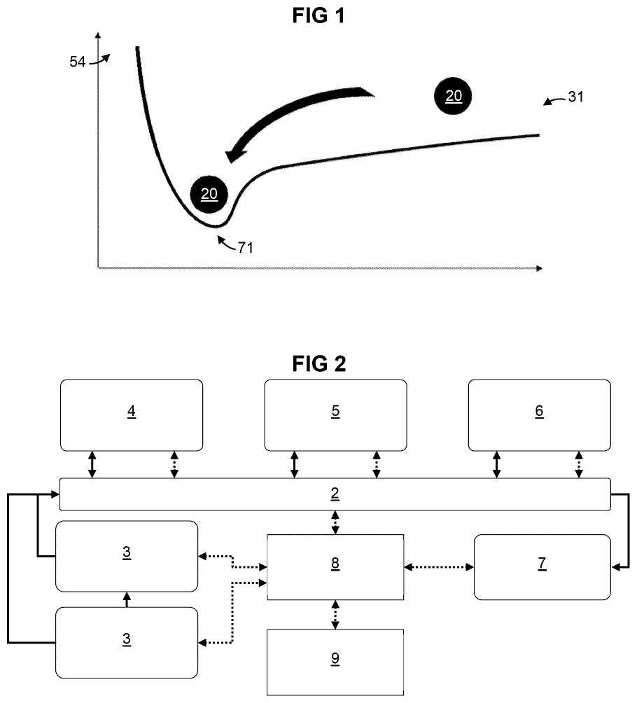

As used herein, and unless otherwise specified, the term “capture site” refers to a location or region within the fluidic channel where the attractive and repulsive forces acting on the target particle create a local potential minimum, thereby trapping and retaining the target particle when it enters the capture site. Such a capture site may not be delimited by walls or surfaces, but by the force fields giving rise to the local potential minimum. This is also schematically depicted in FIG. 1, showing the particle (20) being pulled—i.e., experiencing an attractive force—from the liquid (31) into the capture site (71) where there is a local potential minimum. On the left side—for example, closer to an electric double layer (54)—a repulsive force is pushing the particle back towards to the capture site (71)—i.e., towards the local potential minimum. Note that a local potential minimum entails not only that the attractive and repulsive forces balance out at the minimum (which is also the case for a local potential maximum), but moreover that a small displacement away from the minimum yields a combined force (the sum of the attractive and repulsive forces) pulling the particle back towards the minimum.

As used herein, and unless otherwise specified, the term “attractive force” refers to a force that attracts or pulls the target particle towards a specific location (e.g., a capture site). Examples of attractive forces include, but are not limited to, dielectrophoretic, electrophoretic, electro-osmotic, and other electromagnetic (e.g., generated by the electrodes and) or fluidic forces that can act on the target particle. In example embodiments, the attractive force may have a magnitude roughly in the order of tens to hundreds of piconewton (pN).

As used herein, and unless otherwise specified, the term “repulsive force” refers to a force that repels or pushes the target particle away from a specific location (e.g., the surface of a well). Examples of repulsive forces include, but are not limited to, electrostatic forces, steric forces, and forces arising from interactions between the target particle and an electric double layer (e.g., on the surface of the well). In example embodiments, the repulsive force may a magnitude roughly in the order of tens to hundreds of piconewton (pN).

As used herein, and unless otherwise specified, the term “electric double layer” refers to the structure of charged ions and molecules that forms at the interface between a charged surface (e.g., a surface of or near an electrode when a voltage is applied, or the surface of a charge particle) and an electrolyte solution. The electric double layer typically comprises a compact layer of adsorbed ions and a diffuse layer of mobile ions, which can exert a repulsive force on charged particles near the electric double layer.

As used herein, and unless otherwise specified, when a first entity (e.g., an electrode) is “near” a second entity (e.g., a capture site), it is meant that the first entity is at a distance from the second entity in the order of the size (e.g., an average dimension) of the target particle. For example, the first entity is at a distance from the second entity equal to 10 times the size of the target particle or less; or 7 times or less, or 5 times or less, or 3 times or less, such as 2 times or less.

As used herein, and unless otherwise specified, a set of electrodes “being . . . of the well's depth below/above the top opening” may refer to the location of the top, bottom, or the centre of mass of the set of electrodes below/above the level.

In a first aspect, the present disclosure relates to a module for separating an analyte from a contaminant, comprising: i) a fluidic channel for flowing therethrough a liquid comprising the analyte and the contaminant; ii) a plurality of capture sites in the fluidic channel; and iii) a plurality of electrodes arranged near the capture sites, such that by operating the electrodes both an attractive force and a repulsive force acting on a target particle can be realized, the attractive force and/or repulsive force being tuneable so that the forces acting on the target particle create a local potential minimum at one of the capture sites, thereby capturing the target particle at the capture site, the target particle being either the analyte or the contaminant. Such a module is herein also referred to as a “separation module.”

In example embodiments, the module may comprise (or may be) a single chip or a package of several chips. In example embodiments, the module may be a cartridge (cf. infra).

The liquid may, for example, be or comprise a sample of a complex mixture, such as urine, blood, or a bioreactor sample. The sample may have varying degrees of complexity, such as a growth medium, a lysed growth medium, or a centrifuged sample.

In example embodiments, the liquid may further comprise ionic species (e.g., at least one, but may be more). In example embodiments, the liquid may have an ionic strength of from 1×10⁻⁶ to 10 M. For example, the liquid (e.g., water) may comprise an agent for buffering a pH of the liquid and/or for adjusting an ionic strength of the liquid. In general, the target particle may-but does not need to be-ionic itself. The ionic species further comprised in the liquid are generally distinct from the target particle as such (i.e., different from the target species). In example embodiments, the ionic species may comprise one or more selected from: an alkali metal cation (e.g., Na⁺or K⁺), an alkaline earth cation (e.g., Mg²⁺or Ca²⁺), a polyatomic cation (e.g., NH₄⁺), a halogen ion (e.g., Cl⁻or Br⁻), or a polyatomic anion (e.g., OH⁻, SO₄²⁻, PO₄³⁻, etc.). In example embodiments, the ionic species may derive from a salt, such as NaCl, KCl, CaCl₂. etc.

In example embodiments, the target particle may have a size (e.g., a Stokes or hydrodynamic radius) in the range of 0.5 nm to 5 μm, or 1 nm to 1 μm. In example embodiments, the target particle may be a polarizable target particle. Polarizable target particles can experience a dielectrophoretic force in a non-uniform electric field.

The module may, in example embodiments, be for separating a plurality of analytes from one or more contaminants, and/or a plurality of contaminants from one or more contaminants. This may, for instance, involve capture sites attuned to different target particles (cf. infra).

In example embodiments, the module may further comprise: iv) a controller (e.g., a CMOS-based controller) for operating the electrodes. In example embodiments, the controller may further be for controlling a flow through the fluidic channel. Enacting control on the flow may, for instance, be achieved by (e.g., means of) a pump or valve, optionally in combination with a flow meter for measuring the flow rate. In example embodiments, the controller may fully control the electrodes and/or flow. In example embodiments, the controller may receive external input (e.g., external instructions, such as frequency and strength of the electrical field, flow rate, etc.), and the controller may implement the external input. Such an on-chip/in-package controller provides (e.g., allows) close and direct control/regulation over various components (e.g., electrodes and flow) in the module, while facilitating parallelization and a small footprint on the system level.

In example embodiments, the fluidic channel may comprise or be fluidically coupled to a first inlet for receiving the liquid comprising the analyte and the contaminant. In example embodiments, the fluidic channel may comprise a second inlet for receiving a buffer (e.g., a washing or reaction buffer). In example embodiments, the fluidic channel may comprise one or more outlets for extracting the separated analyte and/or contaminant. In example embodiments the fluidic channel can comprise further inlets (e.g., for further liquids comprising the analyte and contaminant, or further buffers) and/or outlets. The fluidic channel can have various inlets and outlets, allowing controlled and independent introduction of the liquid and buffer, and recovery of the separated analyte and/or contaminant.

In example embodiments, the module may comprise one or more arrays of the capture sites For example, each array may comprise at least 5 capture sites, or at least 20, or at least 50, or at least 100, or at least 200, or at least 500, such as 1000, 2000, 5000, 10000, etc. In example embodiments, the module may comprise at least 5 arrays, or at least 10, or at least 20, or at least 50, or at least 100, or at least 200, such as 500, 1000, etc. Indeed, the capture sites of the present disclosure lend themselves particularly well to being (highly) parallelized/multiplexed. Moreover, providing the captures sites in a (relatively dense) array and then arranging a plurality of the arrays in the fluidic channel allows a very large number capture sites and thus thereby a high exposure of the target particle to the capture sites, thereby increasing the effectiveness of the module.

In example embodiments, the fluidic channel may snake so as to cover at least 50% of a zone having a length and a width of each at least 5 times the fluidic channel's width, or at least 70%, or at least 90%. This provides (e.g., ensures) that the fluidic channel substantially covers the zone, thereby maximizing the capture area for a given footprint.

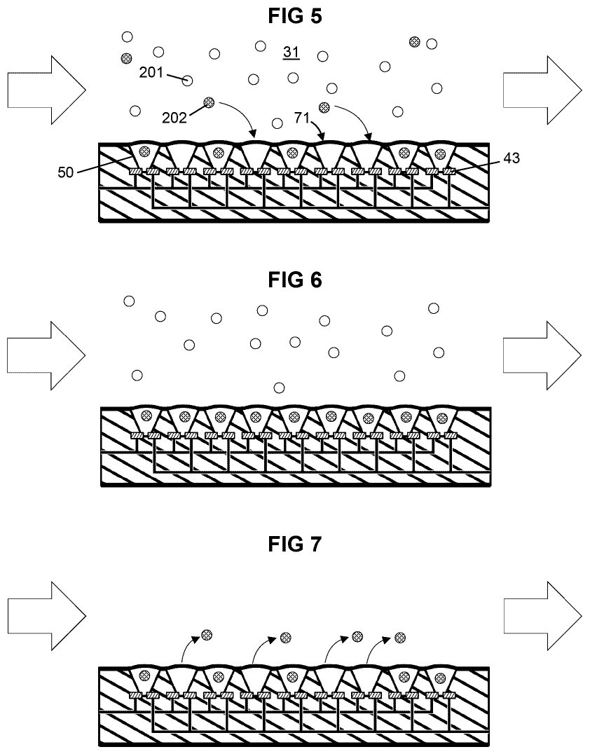

In example embodiments, the captures sites may be near a bottom or top of the fluidic channel. In example embodiments, the fluidic channel may have a height (H in FIG. 4) equal to 1000 times the size of the target particle or less, or 500 times or less, or 200 times or less, or 100 times or less, or 50 times or less, such as 20 or 10 times or less. Such a channel height provides (e.g., ensures) that the target particle is at a distance from the captures sites where the attractive force can adequately act on the target particle.

In example embodiments, the module may comprise a plurality of wells. Each well may have a top opening up to the fluidic channel, a bottom, and a depth extending from the top to the bottom. In example embodiments, a capture site may be situated near the top of the (e.g., each) well. The presence of wells in the fluidic channel helps in providing (e.g., defining) the capture sites, for example, by increasing the effect of certain forces (e.g., the EDL force, cf. infra) and/or by facilitating the formation of a non-uniform electric field (e.g., due to break in symmetry between the well and bulk electrolyte). In example embodiments, the module may comprise a plurality of capture devices, each capture device comprising: at least one of the wells; a first set of electrodes at least 50% of the well's depth below the top opening, or at least 65%, or at least 75%, for generating an electric field. In example embodiments, the module may further comprise a second set of electrodes at most 50% of the well's depth below the top opening, or at most 35%, or at most 25%. Such configurations provide capture devices in which the attractive and/or repulsive forces can be (e.g., very effectively) controlled through operating the electrodes.

The well may not be limited by its shape. Notwithstanding, the well may, for example, be shaped as a cube, a rectangular cuboid, a (truncated) pyramid, a cylinder, a (truncated) cone, etc. Accordingly, the top opening may be square, rectangular, round, oval, etc.

The top opening may have two perpendicular dimensions, the shortest of which may be referred to as its “width” and the longest as its “length” (or both as the “diameter” in case of a round top opening). In example embodiments, the top opening may have a width of from 5 nm to 10 μm, or from 10 nm to 5 μm, or from 20 nm to 2 μm, or from 50 nm to 1 μm, or from 100 nm to 500 nm. In example embodiments, the top opening may have an aspect ratio (i.e., width:length) of from 1:1 to 1:5000, or from 1:1 to 1:1000, or from 1:1 to 1:500, such as 1:1 to 1:200, 1:1 to 1:100, 1:1 to 1:50 or 1:1 to 1:20. The top opening may often be perpendicular to the well's depth (i.e., the top opening's width and length may be perpendicular to the well's depth), but in general this may not be necessary and the top opening may make a minimal angle with the well's depth of at least 30°, or at least 45°, or at least 60°, or at least 75°, or at least 80°, such as 85° or 90° (i.e., perpendicular).

In example embodiments, the well's depth may be from 5 nm to 10 μm, or from 10 nm to 5 μm, or from 20 nm to 2 μm, or from 50 nm to 1 μm, or from 100 nm to 500 nm. In example embodiments, the aspect ratio of the well's depth to the top opening's width may be from 10:1 to 1:10, or from 5:1 to 1:5, or from 2.5:1 to 1:2.5, or from 1.5:1 to 1:1.5, or 1:1. In example embodiments, the well may have a footprint (e.g., the area of the orthogonal projection of the well onto the substrate wherein the well is provided) of from 4 nm² to 1000 μm², or from 25 nm² to 250 μm², or from 100 nm² to 40 μm², or from 0.01 μm² to 10 μm².

The well may be provided (e.g., defined) between a bottom, one or more sidewalls and a top. In some example embodiments, one or more of the electrodes—or a covering layer thereover (cf. infra)—may further provide (e.g., define) the well. The top may be open and coplanar with the sidewalls. In example embodiments, the well may be at least partially delineated by a surface comprising a dielectric material (e.g., SiO₂, SiNₓ or HfO₂). In example embodiments, at least the sidewalls may comprise the dielectric material. For example, the well may be formed in a dielectric layer. The dielectric material may provide insulation between the electrodes. Moreover, it may offer a good surface (e.g., a good isoelectric point) for forming a suitable electric double layer thereon as such, or which lends itself well for surface engineering to that effect. In example embodiments, a surface of the well may be modified so as to control an electric double layer formed thereon. For example, the surface may be modified by a surface treatment (e.g., a plasma treatment) and/or a coating.

In some example embodiments, the bottom may be at least partially open. In example embodiments, the bottom may open down to a further fluidic channel (e.g., galvanically separated from the first fluidic channel). Thus, the well may be (akin to) a nanopore between the first/top and second/bottom fluidic channel. In such example embodiments, the system may further comprise an electrode in the top fluidic channel and an electrode in the bottom fluidic channel. Applying an electric potential between these electrodes can then allow to give rise to further effects/forces which can act upon the target particles, such as electrophoretic (e.g., related to F=qE) and/or electro-osmotic (e.g., related to F=6πεr) forces. Moreover, it can offer other target particle detection approaches (cf. infra), e.g., via resistive pulse sensing.

In example embodiments, the first set of electrodes may be at least 80% or 90% of the well's depth below the top opening. The first set of electrodes may extend-and even be below the well's bottom. Accordingly, the first set of electrodes may in example embodiments be at most 150% of the well's depth below the top opening, or at most 135%, or at most 125%, or at most 120%, such as at most 110%.

In example embodiments, the electric field may be a non-uniform (e.g., spatially inhomogeneous) electric field. A non-uniform electric field gives rise to dielectrophoresis, which can be used to exert a force onto (e.g., attract) a polarizable target particle (cf. infra). The generated (non-uniform) electric field may extend in and beyond the well, such that it can exert a non-negligible (dielectrophoretic) force onto a target particle outside the well.

In example embodiments, the capture device may further comprise a second set of electrodes at most 50% of the well's depth below the top opening, or at most 35%, or at most 25%. Akin to the first set of electrodes, the second set of electrodes may extend-and even be-above the top opening. Accordingly, the second set of electrodes may, in example embodiments, be at most 50% of the well's depth above the top opening, or at most 35%, or at most 25%, or at most 20%, such as at most 10%. The second set of electrodes may be for generating a further electric field. Together with the first set of electrodes, this can be used to form a more complex (e.g., multipole) combined electric field. Not only does such a combined electric field have a larger reach (i.e., extending the deeper into the liquid, but it can also induce other effects (e.g., electrorotation)). Accordingly, use of a second set of electrodes allows, on the one hand, to affect target particles further out from the well, and, on the other hand, to produce further effects which can be used (cf. infra) for differential capturing and/or for diversified signal detection.

In example embodiments, the first and/or second set of electrodes may comprise at least two electrodes, such as (e.g., consisting of) two, three, four or even more electrodes. In example embodiments, the electrodes may independently be made of a conductive material (e.g., Pt, Ru or TiN). In example embodiments, one or more of the electrodes may be provided on an adhesion layer (e.g., Ti, TiN, Cr or TaN). Such an adhesion layer may prevent delamination of the electrode. Additionally or alternatively, a covering layer (e.g., SiO₂, SiNₓ or HfO₂) may be provided over one or more of the electrodes. Since only capacitive currents may be used (e.g., needed) in the operation of the capture device (cf. infra), at least some of the electrodes may be insulated by a covering layer to prevent Faradaic currents (e.g., arising due to electrochemical reactions). Moreover, this can also protect the electrode material from direct contact with the liquid, which might damage certain electrode materials (e.g., corrosion of A1 in an electrolyte), particularly when a high potential is involved (e.g., electrochemical corrosion of Ru due to oxidation above a certain voltage). Notwithstanding, such a covering layer may typically be relatively thin (e.g., in the order few nm to a few tens of nm, such as 2-20 nm).

Several factors may influence the generated electric field and the force exerted onto the target particle, including, for example, the size, geometry, configuration, and operation (e.g., frequency) of the electrodes, as well as the nature (e.g., polarizability) of the target particle. Trial-and-error may be used to configure and operate suitable electrodes in order to achieve a suitable effect onto a target particle in the fluidic channel.

In example embodiments, a plurality of the capture devices may have the same characteristics, and/or a plurality of the capture devices may have different characteristics. For example, the system may comprise one or more arrays wherein the capture devices have the same characteristics within an array and different characteristics between arrays. Herein, “characteristics” may for example comprise the size of the well (e.g., of the top opening) and the nature of the well (e.g., its surfaces). The nature of the well's surfaces-and in particular the isoelectric point, which has a substantial effect on the electric double layer which is formed on the surface-may be controlled by surface engineering. As such, wells of different nature may comprise the surfaces of the wells being composed of different materials (e.g., different dielectrics), and/or having been subjected to a different surface treatment and/or coating (cf. supra).

In example embodiments, the system may comprise capture devices having differently sized wells. Since the characteristics of the capture device play a (e.g., significant) role in determining which target particles can be captured by it, a system comprising captures devices with different characteristics may be particularly suited for capturing different types of target particles.

In example embodiments, the system may further comprise driving and/or read-out circuitry (e.g., CMOS-based) for operating the electrodes.

In some example embodiments, the system may be a sensor probe. For example, the sensor probe may be configured for being inserted directly into the liquid. Such a sensor probe is a convenient form for using the present system, for example, for performing an action (e.g., a measurement) in reactor, such as a bio-reactor.

In example embodiments, the fluidic channel may be provided by an impermeable barrier having a permeable portion, such as a semi-permeable portion. In example embodiments, the (semi-)permeable portion may be formed by a filter (e.g., a porous membrane or a nanoporous membrane) or a microfluidic sampling system. In example embodiments, the (semi-)permeable portion may comprise pores with an average width of 1000 μm or less; or 500 μm or less, or 200 μm or less, or 100 μm or less, or 50 μm or less, or 20 μm or less. A (semi-) permeable portion (in an otherwise impermeable barrier) may (selectively, such as based on size-exclusion and/or chemical affinity) prevent certain particles and/or chemical species from entering the fluidic channel, where they could interfere with the operation of the capture device. Alternatively or additionally, it can be used to dilute the liquid with a sampling buffer to achieve more favourable measurement conditions (e.g., in terms of pH or conductivity).

In example embodiments, any feature of any example embodiment of the first aspect may independently be described for any example embodiment of any of the other aspects.

In a second aspect, the present disclosure relates to a system comprising a plurality of fluidically and/or electronically coupled modules, at least one of the modules being a module according to any example embodiment of the first aspect. Such a system is herein also referred to as a “modular system.”

In example embodiments, one or more further modules may be selected from a supply module, a synthesis module, an analysis module, a collection module, a control module, and a user interface module. Systems in accordance with the present disclosure can combine several and various modules, thereby allowing to make an integrated all-in-one system adapted for a (e.g., specific) target application or usable for a variety of target applications. In example embodiments, the control module may be for controlling the operation and interaction of one or more of the other modules. In example embodiments, the control module may be adapted for performing—or participating in performing (e.g., steering/directing)—the method according to any embodiments of the second aspect.

In example embodiments, the modules may be (fluidically and/or electronically) coupled in series or in parallel or a combination thereof. Coupling modules (equivalent or distinct) in series allows to string processing steps and thereby realize more involved/complex processing (e.g., multi-step synthesis, higher purity, combinations of synthesis, separation and analysis, etc.). Coupling of modules in parallel allows higher throughput (e.g., by performing the same step in parallel across multiple modules) or multiplexing (e.g., targeting different molecules across multiple distinct modules).

In example embodiments, the system may further comprise an electrofluidic (i.e., fluidic and electronic) backplane. An electrofluidic backplane allows the modules to be (e.g., easily and straightforwardly) intercoupled—both fluidically and electronically—through the backplane. In example embodiments, the modules may have a standardized interface (e.g., a standardized fluidic flow interface and/or a standardized electronic interface). Standardized interfaces allow the modules to be straightforwardly connected to the system and to be easily exchanged, interchanged, and/or reconfigured.

In example embodiments, one or more of the modules may be a cartridge. In example embodiments, the system may be adapted for receiving one or more of such cartridges. Modules in the form of cartridges allow easy removal and replacement. Moreover, it allows for the combination of disposable modules (e.g., which may need to be replaced between different uses, as the disposable modules may have become contaminated by the previous use, such as in the case of a synthesis module or a separation module) and non-disposable modules (e.g., which do not readily become contaminated and therefore can be reused repeatedly, for example, in the case of control module or user interface module), while minimizing needless waste. In other example embodiments, the module may be integrated into the system as a fixed component (i.e., in a relatively permanent fashion).

In example embodiments, any feature of any embodiment of the second aspect may independently be as correspondingly described for any embodiment of any of the other aspects.

In a third aspect, the present disclosure relates to a method for separating an analyte from a contaminant, the method comprising: a) flowing a liquid comprising the analyte and the contaminant through the fluidic channel of a module as provided (e.g., defined) in any embodiments of the first aspect; and b) operating the plurality of electrodes so as to realize both the attractive force and the repulsive force acting on the target particle, and tune the attractive force and/or repulsive force so that the forces acting on the target particle create a local potential minimum at one of the capture sites, thereby capturing the target particle at the capture site, wherein the target particle is either the analyte or the contaminant.

In example embodiments, the method may further comprise: c) releasing and collecting the target particle. This allows recovery of the separated analyte or contaminant.

In example embodiments, the target particle may be the analyte and the concentration of the analyte may be lower than that of the contaminant, or the target particle may be the contaminant and the concentration of the contaminant may be lower than that of the analyte. The method may provide (e.g., enable) two main modes of operation: selective capture of (low concentration) contaminants or up-concentration of (low concentration) analytes.

In example embodiments, step b may comprise generating a non-uniform electric field such that the attractive force is an attractive dielectrophoretic force acting on the target particle. In example embodiments, the attractive dielectrophoretic force-also referred to as “positive” dielectrophoresis-may be directed towards the electrodes (e.g., the first and/or second set of electrodes), such as (at least) towards the first set of electrodes. In example embodiments, the non-uniform electric field may have its highest field strength at or near the first set of electrodes (e.g., at the edges of the first set of electrodes). Positive dielectrophoresis is directed towards the highest field strength, so by having the highest field strength around the first set of electrodes which are situated towards the bottom of the well-the target particle may experience an attractive force pulling it into the well.

In example embodiments, step b may comprise applying to (at least some of) the electrodes an alternating voltage (AC voltage), optionally combined with a direct voltage (DC voltage or bias) (i.e., an alternating voltage offset by a constant bias). In example embodiments, wherein the capture device comprises the first and second set of electrodes, step b may further comprise applying to the first set of electrodes an alternating voltage, optionally combined with a direct voltage. The alternating voltage(s) may for example (independently) have a sinusoidal, trapezoidal or rectangular waveform. In example embodiments, step b may comprise modulating the operation—e.g., the applied voltage, namely the AC and/or DC magnitude and AC frequency—of the at least first set of electrodes to tune the attractive dielectrophoretic force to the target particle. In example embodiments, the alternating voltage may have an AC frequency range of from 1 kHz to 1 GHz, such as 10 kHz to 100 MHz. In example embodiments, the alternating voltage and/or the direct voltage may have a magnitude of from −5 to 5 V, or from −1 to 1 V, or from −500 to 500 mV, such as at least −25 mV to 25 mV. In example embodiments, wherein the capture device comprises the first and second set of electrodes, step b may comprise modulating the operation of the first and second set of electrodes to tune the attractive dielectrophoretic force to the target particle. Along with the relative polarizability of the target particle and the medium, the dielectrophoretic force experienced by a particle may at partially depend on the non-uniform electric field. This includes not only the magnitude of the force but also its direction (e.g., positive/towards or negative/away from the highest field strength), and this through respectively the (local) field strength and the field frequency. As such, by controlling the voltage (e.g., the AC and/or DC magnitude and AC frequency) applied to the first and/or second set of electrodes, one can not only change the strength of the attractive force experienced by an target particle but also selectively—for example, with respect to a further target particle or a contaminant—tune it towards the target particle.

In example embodiments, the well may be at least partially lined with an electric double layer (EDL). The characteristics of the EDL (e.g., its size) typically depend on the pH of the liquid and the nature of the underlying surface on which it is formed, particularly in terms of its isoelectric point. The isoelectric point is the pH at which the surface carries no net electrical charge, so at any other pH the surface will carry a net charge and develop an EDL (and increasingly so the further one moves away from the isoelectric point). As such, the well may (e.g., always) be at least partially line with an EDL.

Moreover, the EDL which is formed may be influenced by adjusting the pH of the liquid. Additionally, the DC bias of the electrodes also affects the EDL, so that the EDL near the electrodes (e.g., the EDL on the electrode surface or on a thin covering layer, cf. supra) can also be influenced by tuning the DC bias.

In example embodiments, the repulsive force may be between the target particle and an electric double layer formed near the electrodes. Like the surface of the well, the target particle may typically have its own EDL. As the target particle is then attracted towards and into the well, its own EDL will interact with that of the well, creating ionic concentration differences which generate an osmotic pressure and thereby a repulsive force (which may be referred to as “EDL force”) between the target particle and the well. While the EDL force may be dominant, even in the absence of an EDL on the target particle, the latter will anyway experience a repulsive force as it gets closer to the well's surface (e.g., at least through a steric effect with the well's EDL or ultimately with the well's surface as such).

Thus, the modules, systems, and methods in accordance with the present disclosure allow a target particle of interest to be captured by the interplay of (tuneable) attractive and repulsive forces. Most typically, these forces may include at least an attractive dielectrophoretic force and a repulsive EDL force. However, they may more generally include an interplay of any two or more of: dielectrophoretic (positive and/or negative), EDL, electrophoretic, electro-osmotic, steric, Coulomb, etc. forces.

In example embodiments, capturing the target particle from the liquid may comprise selectively capturing the target particle with respect to a further target particle (e.g., target particles of another target particle species) or a contaminant. For a captured target particle (at rest), the attractive and repulsive forces are (overall) in balance. However, whether this balance point can be reached—and if so, where it is located—depends on the particle (e.g., its polarizability, charge, EDL, etc.), and the interplay of these forces. Moreover, these forces may be (individually) controlled and tuned. As such, not only does it become possible to capture a target particle selectively (with respect a further target particle or a contaminant); the tuning of the forces also allows specific targeting of a particular species of target particle.

In example embodiments, step b may comprise tuning the attractive force and/or repulsive force near two or more capture sites to capture a dissimilar target particle at each capture site. As noted previously, the present disclosure (e.g., especially) excels when the system comprises a (large) plurality of capture devices. Indeed, a range of factors—both through manufacturing (e.g., well size and/or surface functionalization/modification) and during operation (e.g., the applied AC and/or DC voltage magnitude and AC voltage frequency, to the first and/or second electrodes individually)—can be tuned differently for different capture devices, so that these can be targeted toward different target particles of interest. Thus, within a single system, an arbitrarily large number of capture devices can, in principle, be configured for selectively capturing various target particles. Moreover, since at least some of these factors can be tuned in operation, the modules, systems, and methods in accordance with the present disclosure need not be fabricated for a specific application, but can be more universal and then fine tuned to the application during use (e.g., also allowing them to be reconfigured for other applications).

In example embodiments, the method may further comprise: detecting whether the target particle is captured by the well; analysing the captured target particle; and/or separating the captured target particle from the liquid. In some example embodiments, detecting and/or analysing the target particle may, for example, comprise determining a capacitance measured between the first and/or—if present—second set of electrodes (and thus detecting whether the target particle is captured by the well through the measured capacitance). In alternative or complementary example embodiments, the method may also comprise resistive pulse sensing (cf. supra). In example embodiments, separating the captured particle from the liquid may comprise capturing the particle and subsequently flushing the liquid in the fluidic channel (e.g., before releasing the captured target particle back into the fluidic channel).

The present disclosure may be used in various application areas where a reliable, non-destructive method to characterize and purify certain analytes of interest is useful. For example, the present disclosure may be used to measure the size and/or distribution (or dispersity)—but also other characteristics (cf. supra)—of: liposomes in liposome drug product manufacturing; viruses in virus variant detection and/or viral vector product manufacturing; vesicle and/or sub-cellular organelles in sample preparation based on cellular components; biopolymer (e.g., polynucleotide or polypeptide) fragments in (cell-free) biopolymer level screening, or pre-screening prior to biopolymer sequencing; contaminant particles in chemicals used for semiconductor manufacturing; etc. Being reliable and non-destructive, the present disclosure may be favourable in quality control in the above and other application areas.

In example embodiments, any feature of any embodiment of the third aspect may independently be as correspondingly described for any embodiment of any of the other aspects.

The disclosure will now be described by a detailed description of several embodiments of the disclosure. Other embodiments of the disclosure can be configured according to the knowledge of the person skilled in the art without departing from the true technical teaching of the disclosure, the disclosure being limited only by the terms of the appended claims.

### Example 1: Modular System

An example modular system (1) in accordance with the present disclosure is schematically depicted in FIG. 2; comprising a plurality of modules coupled to one another by fluidic connections (solid lines)—e.g., via an electrofluidic backplane (2)—and/or electronic connections (dotted lines, such as data and/or control connections). Such a modular system (1) may for example be shown in FIG. 2. The modular system (1) may include a supply module (3). The modular system (1) may include two such modules (3), of which one (bottom) connects to external fluidics (e.g., a pump) and one (top) represents an internal supply of reagents. The modular system (1) may also include a synthesis module (4) for synthesizing one or more analytes, a separation module (5) for separating (or purifying) the one or more analytes from one or more contaminants (e.g., undesired side products), an analysis module (6) for analysing (some of) the analytes and/or contaminants, a collection module (7) for collecting (some of) the analytes and/or contaminants, a control module (8) for controlling the operation and interaction of the various modules, and a user interface module (9) for allowing input (e.g., selection of settings, program, etc.) from and/or output (e.g., analysis data) to a user.

This is one of many possible configurations for such a modular system, to which modules can be added or removed as desired for the application at hand. For example, formation of a desired end product may involve a multi-step synthesis, in which case the modular system (1) may comprise a plurality of synthesis modules (4) and separation modules (5)—and optionally analysis modules (6). In another example, rather than reagents, the supply module (3) may be for supplying a (complex) sample (e.g., a blood sample) and the modular system (1) may comprise one or more separation modules (5) and analysis modules (6), but no synthesis module (4). Each module may comprise a standardized fluidic flow interface for coupling to the electrofluidic backplane (or similar connecting structure), thereby allowing seamless exchange of modules.

In general, in a modular system (1) in accordance with the present disclosure, the aforementioned modules—safe for the separation module (5)—may be optional.

### Example 2: Separation Module

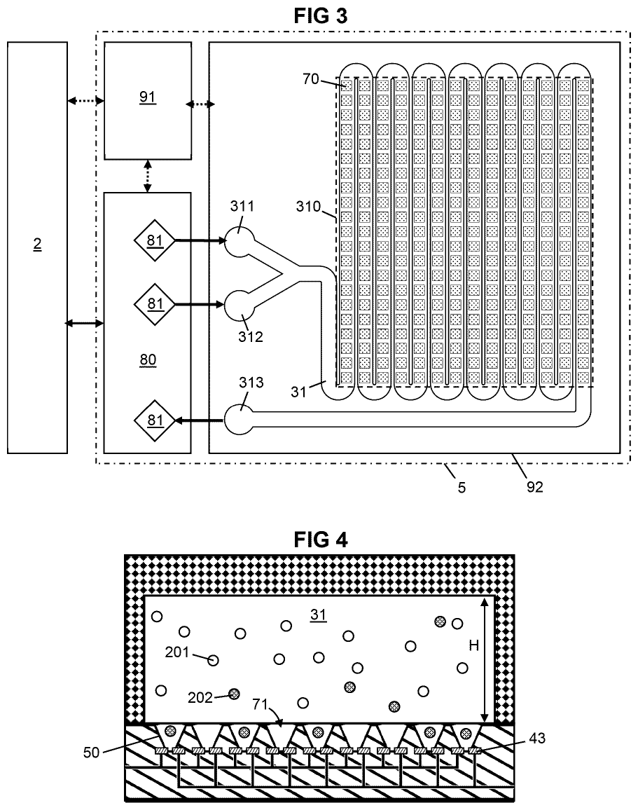

Referring now to FIG. 3, which schematically illustrates a possible separation module (5) in accordance with the present disclosure; for example for integration into a modular system as described above. For example, the separation module (5) may be integrated into a system (e.g., a modular system as above) as a fixed component (i.e., in a relatively permanent fashion) or as a cartridge that can be easily removed and replaced (with the system being adapted for receiving such a cartridge).

The separation module (5) as shown in FIG. 3 includes a first inlet (311) for receiving the liquid comprising the analyte and the contaminant, and a second inlet for a buffer (e.g., a wash buffer). The first inlet (311) and second inlet (312) are connected to a serpentine fluidic channel (31). This fluidic channel (31) is designed to snake/meander/bend upon itself to cover a substantial area of a zone (310), thereby having a large area available for capture sites in this zone (310) and thus allowing maximal contact between the liquid and the capture sites (in turn providing (ensuring) an effective capture of the target molecule within a compact space). The plurality of capture sites in the fluidic channel (31) are provided in the form of arrays (70), each comprising a plurality of the capture sites. The fluidic channel (31) continues to the outlet (313), where the separated analyte(s) and/or contaminant(s) can be extracted. The separation module (5) further comprises a fluidic flow interface (80), with fluidic valves (81) coupled to each of the first inlet (311), second inlet (312), and outlet (313). The fluidic flow interface (80) further couples with the electrofluidic backplane (2). Moreover, the separation module (5) may comprise a controller (91), providing on-chip/in-package electronic control—that may be steered from the outside (e.g., by a control module; cf. supra)—for the electrodes and valves. The controller (91) also couples to the electrofluidic backplane (2) to allow coordinated operation and/or data exchange with other modules (e.g., via the control module).

A separation module (5) in accordance with the present disclosure may for instance be configured as a single chip or a package of several chips. As illustrated in FIG. 3, the module (5) is a package comprising the fluidic flow interface (80), the controller (91), and the separation chip (92).

FIG. 4 schematically shows a cross-sectional view (perpendicular to the flow direction) of a fluidic channel in accordance with the present disclosure. The fluidic channel (31) provides (e.g., defines) the path through which the liquid—containing both one or more analytes (201) and contaminants (202)—flows. As depicted, the fluidic channel (31) has a plurality of wells (50) and electrodes (43) positioned near (e.g., underneath and/or adjacent to) the wells (50), thereby providing (e.g., defining) a plurality of capture sites (71).

### Example 3: Use of the Separation Module

There are generally two main operation modes in which the separation module may be used.

### Example 3A: Using the Separation Module to Selectively Remove one or More Contaminants

In the first main operation mode, the target particles may be one or more contaminants (202), and the liquid may be purified by capturing and removing a contaminant (202) selectively with respect to the analyte (201). This mode may be most suited when the concentration of the contaminant (202) is lower than that of the analyte (201).

As shown in FIG. 5, the liquid may to this end first be flown through the fluidic channel (31) and “over” the capture sites (71). By tuning the operation of the electrodes (43)—e.g., to generate a particular non-uniform electric field—one or more of the forces (e.g., an attractive dielectrophoretic force) acting on the particles can be modulated such that there is a local potential minimum at the capture sites only for the contaminant (202), and not for the analyte (201). In other words, the capture sites (71) are attuned selectively towards the contaminant (202). As the contaminant (202) is captured, the purified liquid continues to flow towards an outlet (and e.g., a subsequent collection or further processing module). Multiple different contaminants (202) may be captured within a single module by varying the operation of different electrodes (43) and/or having wells (50) with distinct characteristics (e.g., different sizes), thereby attuning different capture sites (71) to different contaminants (202).

Optionally, the occupancy of the captures sites (71) may be monitored using e.g., impedance measurements. When—as shown in FIG. 6—a certain level of occupancy is reached (e.g., substantially all capture sites (71) are saturated) or when the desired purification has been performed (e.g., all contaminant (202) has been captured or all of the liquid to be purified has been flown over the capture sites (71)), the introduction of additional liquid can be interrupted and the fluidic channel (31) can be washed (e.g., by flowing a washing buffer therethrough), thereby evacuating the remaining analyte (201).

Next, as shown in FIG. 7, the electrodes can be operated to release the contaminant (202) (e.g., by changing one or more of the forces to upset the force balance), and the fluidic channel (31) can again be washed to evacuate the contaminant (202), which may e.g., be collected as waste. When the capture sites (71) have been sufficiently regenerated, the process can start anew.

### Example 3B: Using the Separation Module to Selectively Concentrate one or More Analytes

The second main operation mode is similar to the first, but herein the target particles are one or more analytes (201). This mode may be most suited when the concentration of the analyte (201) is lower than that of the contaminant (202).

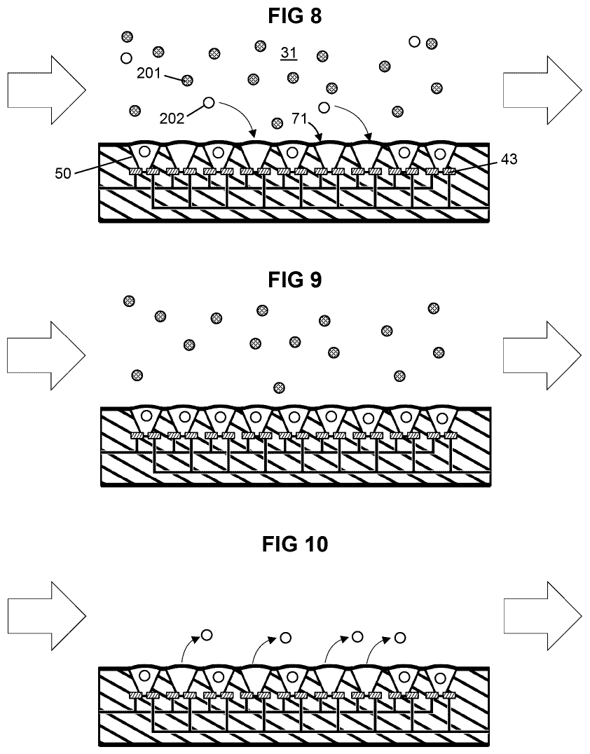

Accordingly, rather than purifying the liquid as it flows through the fluidic channel (31), the analyte (201) becomes concentrated in the capture sites (71); cf. FIG. 8. As the analyte (201) is captured, the depleted liquid continues to flow towards the outlet and can be collected as waste. Multiple different analytes (201) may again be captured within a single module by varying the operation of different electrodes (43) and/or having wells (50) with distinct characteristics (e.g., different sizes), thereby attuning different capture sites (71) to different analytes (201).

Upon reaching a certain level of occupancy (e.g., substantially all capture sites (71) are saturated) or when the desired concentration has been performed (e.g., all analyte (201) has been captured or all of the liquid has been flown over the capture sites (71)), as shown in FIG. 9, the introduction of additional liquid can be interrupted and the fluidic channel (31) can be washed (e.g., by flowing a washing buffer therethrough), thereby evacuating the remaining contaminant (202).

Next, as shown in FIG. 10, the electrodes can be operated to release the analyte (201) (e.g., by changing one or more of the forces to upset the force balance), and the fluidic channel (31) can again be washed to evacuate the concentrated analyte (201), which may subsequent be flown to, for example, a collection or a further processing module. When the capture sites (71) have been (e.g., sufficiently) regenerated, the process can start anew.

### Example 4: Capture Device

### Example 4A: Capture Device Having a Closed Bottom

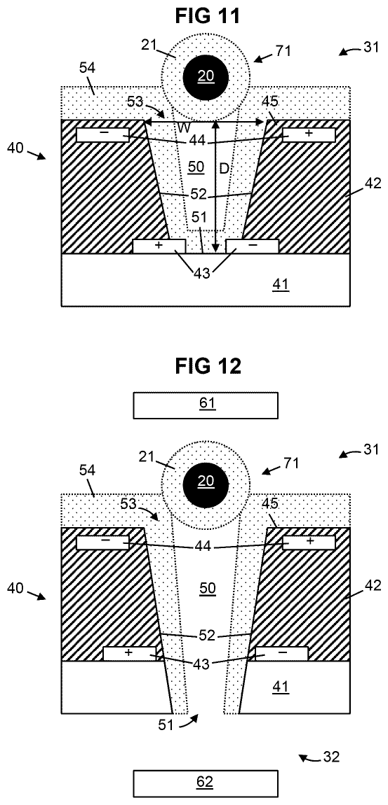

Realizing the plurality of captures sites in a separation module as aforementioned may, for instance, be achieved using a plurality of wells in the fluidic channel, and capture devices formed about these wells. FIG. 11 illustrates such a capture device (40), comprising a well (50) in a fluidic channel (31) with a liquid comprising the target particle (20). The capture device (40) comprises a substrate (41) (e.g., a Si wafer) and a dielectric layer (42) (e.g., SiO₂) thereon, with the well (50) being formed in the dielectric layer (42). A first set of electrodes (43) is situated in a bottom half of the well (50), namely at the bottom of the well (50) (e.g., on the substrate (41)). A second set of electrodes (44) is situated in a top half of the well (50), namely in/covered by a dielectric (e.g., SiO₂) cover layer (45). The well (50) is provided (e.g., defined) between a bottom (51) (which as depicted corresponds to the substrate (41)), the bottom electrodes (43), sidewalls (52) in the dielectric layer (42)/cover layer (45), and a top (53) opening up to the fluidic channel (31). Both the well (50) and the target particle (20) have an electric double layer (54, 21).

In operation, the first (43) and second (44) set of electrodes can be driven so as to generate an attractive dielectrophoretic force on the particle (20). Meanwhile, as the target particle (20) is pulled into the well (50), the particle's EDL (21) and the well's EDL (54) may interact and give rise to a repulsive force. By tuning the dielectrophoretic force, a point can be reached where the attractive force(s) balance out the repulsive force(s), and thus the target particle (20) is (e.g., effectively) captured at a capture site (71). The capture device (40) can be further equipped to detect and/or analyse the captured target particle (20), for example, through performing a capacitance measurement on the well (50).

Although FIG. 11 depicts one capture device (40), the module may comprise many such capture devices in parallel, some of which may have the same characteristics, while others may have different characteristics. By providing wells with different characteristics—such as different sizes, different natures of the surface (for example different isoelectric points, such as through a difference in post-processing) giving rise to different EDL's, etc.—and/or applying different driving profiles to their electrodes, different wells can be configured for capturing different target particles, so that the same module can be used to capture and detect/analyse various target particles in parallel.

### Example 4B: Capture Device Having an Open Bottom

Referring to FIG. 12, FIG. 12 illustrates a capture device (40) which is generally similar to that of FIG. 11 but wherein the bottom (51) of the well (50) is open. As such, the well (50) forms a through-hole (like a nanopore) connecting the upper fluidic channel (31) to a lower fluidic channel (32).

FIG. 12 further depicts an electrode (61) in the top fluidic channel (31) and one (62) in the bottom fluidic channel (31). By applying an electric potential between these electrodes (61, 62), further effects/forces—such as electrophoretic and/or electro-osmotic forces—can be generated to act upon the target particle (20). Additionally, this can also provide (e.g., enable) other ways of detecting and/or analysing the target particle, such as via resistive pulse sensing.

A separation module in accordance with the present disclosure may not (e.g., exclusively) comprise capture devices (40) as depicted either in FIG. 11 and FIG. 12, but that these—as well as still other configurations—could be readily combined and integrated into a single module as desired.

Example embodiments, constructions, configurations, and materials have been discussed herein in order to illustrate the present disclosure. It will be apparent to those skilled in the art that various changes or modifications in form and detail may be made without departing from the scope of the disclosure as provided (e.g., defined) in the appended claims.

What is claimed is:

1. A module for separating an analyte from a contaminant, comprising:
a fluidic channel configured for a liquid to flow through the fluidic channel, the liquid comprising the analyte and the contaminant;
a plurality of capture sites in the fluidic channel; and
a plurality of electrodes arranged near the capture sites, an attractive force and a repulsive force acting on a target particle is realized by operating the electrodes,
the attractive force or the repulsive force is configured to be tuneable, the attractive force or the repulsive force acting on the target particle creates a local potential minimum at least one of the capture sites to capture the target particle at the capture site,
the target particle is the analyte or the contaminant.

2. The module according to claim 1, further comprising:
a controller configured to operate the plurality of the electrodes.

3. The module according to claim 2, wherein the controller is configured to control a flow through the fluidic channel.

4. The module according to claim 1, comprising a plurality of wells, wherein each well has:
a top opening to the fluidic channel,
a bottom, and
a depth extending from the top to the bottom, wherein at least one of the plurality of capture sites is near the top.

5. The module according to claim 4, comprising a plurality of capture devices, each capture device comprising:
at least one well of the plurality of wells;
a first set of electrodes positioned below the top opening and at least 50% of the depth of the well for generating an electric field.

6. The module according to claim 5, wherein each capture device further comprises a second set of electrodes positioned below the top opening and at most 50% of the depth of the well.

7. The module according to claim 1, wherein the fluidic channel snakes to cover at least 50% of a zone having a length and a width of at least 5 times a width of the fluidic channel.

8. The module according to claim 1, wherein the fluidic channel comprises:
a first inlet for receiving the liquid comprising the analyte and the contaminant, and
a second inlet for receiving a buffer.

9. The module according to claim 1, wherein the fluidic channel is fluidically coupled to:
a first inlet for receiving the liquid comprising the analyte and the contaminant, and
a second inlet for receiving a buffer.

10. A system comprising a plurality of fluidically or electronically coupled modules, wherein at least one of the fluidically or electronically coupled modules is a module according to claim 1.

11. The system according to claim 10, wherein one or more of fluidically or electronically modules are a supply module, a synthesis module, an analysis module, a collection module, a control module, or a user interface module.

12. A method for separating an analyte from a contaminant, the method comprising:
flowing a liquid comprising the analyte and the contaminant through a fluidic channel of a module, the module includes
the fluidic channel configured for a liquid to flow through the fluidic channel, the liquid comprising the analyte and the contaminant,
a plurality of capture sites in the fluidic channel, and
a plurality of electrodes arranged near the capture sites; and
operating the plurality of electrodes to realize both an attractive force and a repulsive force acting on a target particle, and
tune the attractive force or repulsive force, wherein the force acting on the target particle create a local potential minimum at one of the capture sites, thereby capturing the target particle at the capture site,
wherein the target particle is the analyte or the contaminant.

13. The method according to claim 12, further comprising releasing the target particle.

14. The method according to claim 12, further comprising collecting the target particle.

15. The method according to claim 12, wherein the target particle is the analyte.

16. The method according to claim 12, wherein a concentration of the analyte is lower than that of the contaminant.

17. The method according to claim 12, wherein the target particle is the contaminant and the concentration of the contaminant is lower than that of the analyte.

18. The method according to claim 12, wherein operating the plurality of electrodes comprises generating a non-uniform electric field, wherein the attractive force is an attractive dielectrophoretic force acting on the target particle.

19. The method according to claim 12, wherein the repulsive force is between the target particle and an electric double layer formed near the electrodes.

20. The method according to claim 12, wherein operating the plurality of electrodes comprises tuning the attractive force or repulsive force near two or more capture sites to capture a dissimilar target particle at each capture site.
